(19) United States
(12) Patent Application Publication
(10) Pub. No.: US 2018/0089858 A1
(43) Pub. Date: Mar. 29, 2018

(54) IMAGE PROCESSING METHOD AND DEVICE

(71) Applicant: MAS INNOVATION (PVT) LIMITED, Colombo (LK)

(72) Inventors: Iddagoda Hewage Don Mavidu Nipunath IDDAGODA, Colombo (LK); Keshan Danura DAYARATHNE, Colombo (LK)

(21) Appl. No.: 15/561,699

(22) PCT Filed: Mar. 29, 2016
(86) PCT No.: PCT/GB2016/050872

§ 371 Date: Sep. 26, 2017

(30) Foreign Application Priority Data
Mar. 27, 2015 (GB) 1505290.5

(51) Int. Cl. G06T 9/20; H04N 1/409; H04N 1/64; H04N 19/14; H04N 19/186; G06K 9/46

(52) U.S. Cl. CPC G06T 9/20; H04N 1/409; G06K 9/4652; H04N 19/14; H04N 19/186; H04N 1/644

(57) ABSTRACT

An image processing method comprising the steps of: acquiring an image to be processed (102); calculating a combined colour index for each pixel in said image, based on the colours contributing to each pixel (108); calculating the gradient of said combined colour index for each pixel to obtain colour gradient change data for the total image; smoothing said gradient change data to highlight relevant colour changes on said image (110); sectoring said smoothed gradient colour change data to allow information to be extracted from each said sector of said image (111); and identifying at least one anchor point or sets of points pertaining to edges within one or more sectors (112).

This invention relates to an image processing method and apparatus. More particularly, the invention relates to an image processing method where particular features of an image can be highlighted and/or extracted from the image by means of a colour change gradient. An effective means of combining primary colours in the original image is described. Gradients are found for the combined colours and an appropriate smoothing function is implemented on the gradients. The gradient data is then used to highlight or extract features from the image.

U.S. 20120287488, U.S. 20120288188 and U.S. Pat. No. 7,873,214 all describe image processing systems and methods that use colour gradient information. More particularly, these inventions discuss different methods to evaluate the plurality of colour in images. In the method as described, regions with particular colour distributions are identified. For images where the colour contents of the features of interest are relatively constant and with a clear distinction of colour between the background of the image and features of interest within the image, the detection and analysis of features is possible.

U.S. Pat. No. 4,561,022 (Eastman Kodak Company) describes a method of image processing to prevent or remove unwanted artefacts or noise from degrading the reproduction of a processed image, which involves the generation of local and extended gradient signals, based on a predictive model. This system is highly accurate for relatively simple applications, but the predictive model may be less successful for dynamic applications, for example processing images that are in a diverse range of sizes and shapes, or images that are patterned.

WO2013/160210A1 (Telecom Italia S.P.A.) describes an image processing method which includes the identification of a group of key points in an image, and for each key point calculating a descriptor array including parameter values relating to a colour gradient histogram.

U.S. 2008/0212873A1 (Canon Kabushiki Kaisha) describes a method of generating a vector description of a colour gradient in an image.

U.S. 2014/0270540A1 (MeCommerce, Inc) describes a method of image analysis relating to the determination of the boundary between two image regions which involves determination of a segmentation area that includes pixels near at or near the boundary. More particularly, this application uses reference objects to search for similar objects in an image.

U.S. 2009/0080773A1 (Hewlett Packard Co.) describes a method for segmenting an image which utilises a dynamic colour gradient threshold.

U.S. Pat. No. 6,281,857 B1 (Canon Kabushiki Kaisha) describes a method for determining a data value for a pixel in a destination image based on data pixels in a source image which utilises an analysis of diagonal image gradients in the source image. Like U.S. 2014/0270540A1, this application uses reference objects to search for similar objects in an image.

This invention provides a simple processing technique to extract information from an image. The invention minimises the amount of processing power required for the image processing and therefore allows the invention to be used across a range of devices, in particular, to be used on devices with minimal processing power.

The invention also provides a simple, computationally fast method to remove noise and/or artefacts via the use of a moving average window based approach. Preferably, the invention can circumvent the problems associated with shape matching algorithms by using an image sectoring procedure and by analysing gradient changes in the sectored image.

According to the invention there is provided an image processing method comprising the steps of: acquiring an image to be processed; calculating a combined colour index for each pixel in said image, based on the colours contributing to each pixel; calculating the gradient of said combined colour index for each pixel to obtain colour gradient change data; smoothing said gradient change data to highlight relevant colour changes on said image; sectoring said smoothed gradient colour change data to allow information to be extracted from each said sector of said image; and determining one or more edge related features within one or more sectors.

Preferably, the step of determining said edge related feature comprises the step of clustering said colour gradient change data.

Preferably, the method may further comprise the step of comparing clustered gradient data with a one dimensional template representative of the shape of said edge, in some embodiments of the invention a scaling function maybe used to scale the clustered gradient data to match the template.

The method may also further comprise an overall conformity check to determine the combination of edges that matches the overall shape of the object in the image.

In a further embodiment of the invention the step of determining at least one edge related feature includes identifying at least one anchor point within one or more sectors.

Preferably the acquired image is an image of an object, such as an article of clothing or a pattern. The determination of gradient change data is particularly relevant to allow the proper detection and determination of feature within each sector. In embodiments of the invention, the anchoring point as identified for each sector can be used to assist in determining a feature such as an edge within each sector.

In a preferred embodiment said combined colour index for each pixel is calculated as follows: combined index=(Z²×Red)+(Z×Green)+Blue where Red, Green and Blue represent the magnitude of that primary colour in each pixel, and Z represents the total range of values available for each colour in the image. Preferably, the value for each of Red, Green and Blue is between 0 and 255, and the value of Z is 256.

Further preferably, smoothing of the gradient colour change data is performed by convolution of the data with a Gaussian window. Preferably, a suitable window length will be determined for each specific image capturing device.

In an embodiment of the invention the parameters of the Gaussian convolution window will adjusted according to the origin of said image. In some cases, the origin of the image is a photograph acquired by a mobile device such as a mobile telephone, or a tablet for example.

Preferably, the step of sectoring the image is performed using a logic process for clustering colour gradient data together. This will reduce the overall problem space.

In a preferred embodiment of the invention the anchoring point for a sector is one pixel within the sector. The invention also provides alternative algorithms to identify gradient changes relevant to the proper detection of anchoring points.

Appropriately identified anchoring points may serve as a basis for looping functions as the image is further analysed and processed.

A preferred embodiment of the invention may also comprise the step of identifying additional anchor points for each sector to assist in defining one or more boundaries of said sector. Typically, the boundary between features in the image and the background (where the background may also include noise for example) are characterised in a suitable manner by identifying specific patterns prevalent in the colour change gradients. The design methodology ensures computational simplicity by first identifying a few principal points in an image and solving the remainder by means of simple iteration.

Further preferably the locations of additional anchoring points are determined by a logic process.

In a further embodiment of the invention information can be extracted from one or more sectors by a logic process. Preferably, the extracted information may be information that is related to an edge feature in the image. The logic process for image extraction may be based on one or more of: a) values of gradient peaks within said sector relative to each other; b) location/occurrence of gradient peaks within said sector relative to each other; c) clusters of gradient peaks governed by distance limiting factors. Looping in the relevant sector may be performed using subroutines that are built-in to the image processing method and can address false identification of features, missing data and automatic correction mechanisms.

In an embodiment of the invention the method further comprises the step of analysing the colour distribution within said image by analysing said combined colour index. Preferably, the results of analysing said colour distribution can be used to identify colour based features in said image. The analysis of the colour distribution can be performed in a computationally simple manner.

According to the invention there is also provided an image processing apparatus for image processing comprising: acquisition means for acquiring an image to be processed; and processor means for processing said acquired image; said processor means: calculating a combined colour index for each pixel in said image, based on the colours contributing to each pixel; calculating the gradient of said combined colour index for each pixel to obtain colour gradient change data; smoothing said gradient change data to highlight relevant colour changes on said image; sectoring said smoothed gradient colour change data to allow information to be extracted from each said sector of said image; and determining edge related features for one or more sectors.

The present invention will now be described, by way of example only, with reference to the accompanying drawings, in which:

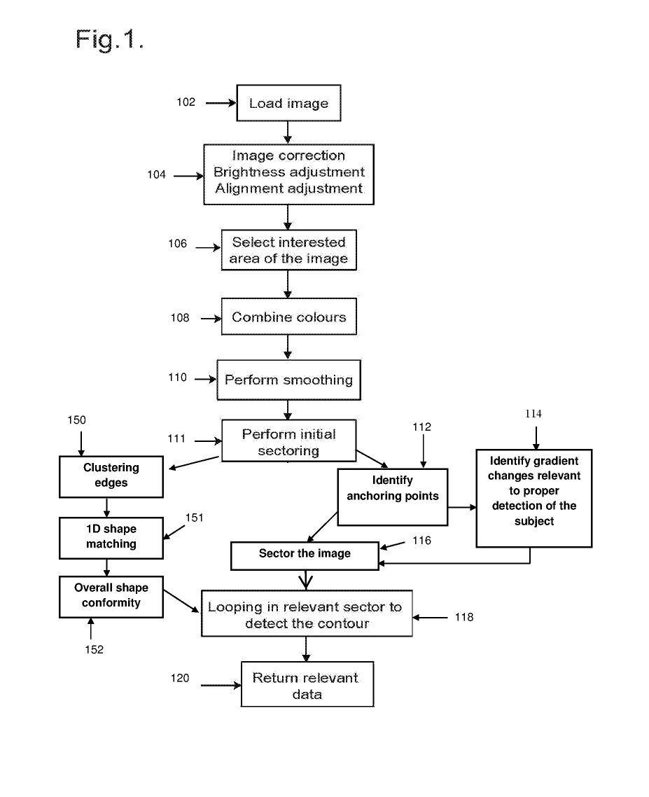

FIG. 1 is a flow diagram of the image processing method;

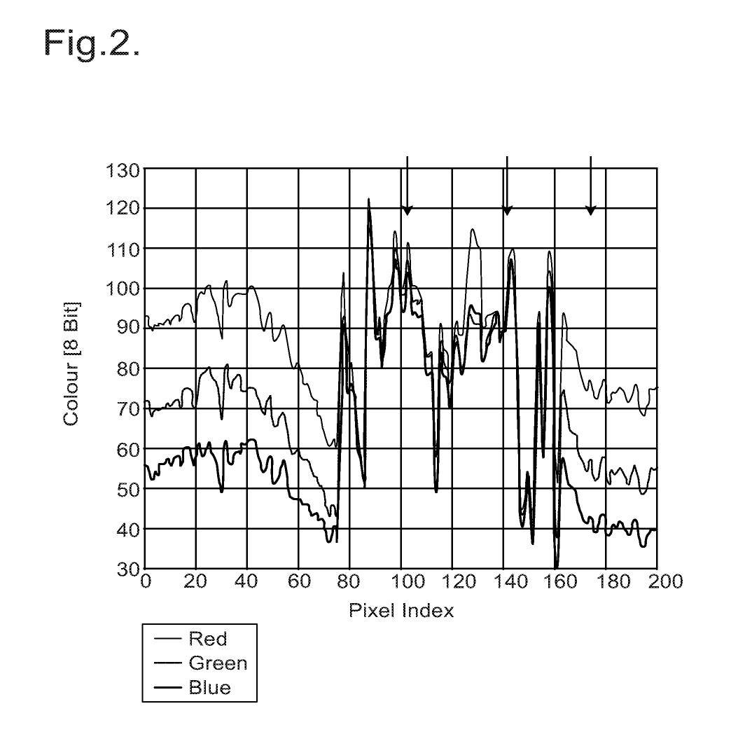

FIG. 2 shows a primary colour breakdown of 200 pixels with high colour variance;

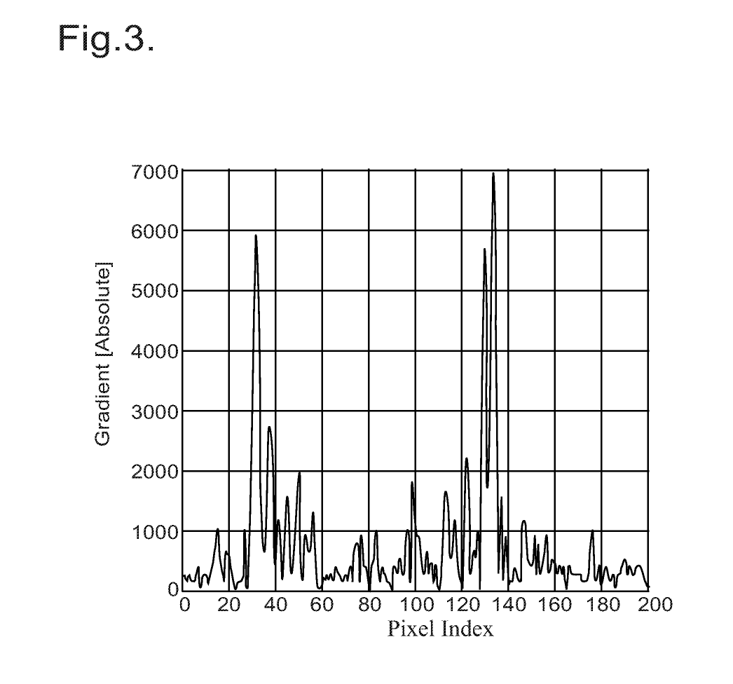

FIG. 3 shows the gradient information obtained from the combined data of FIG. 1;

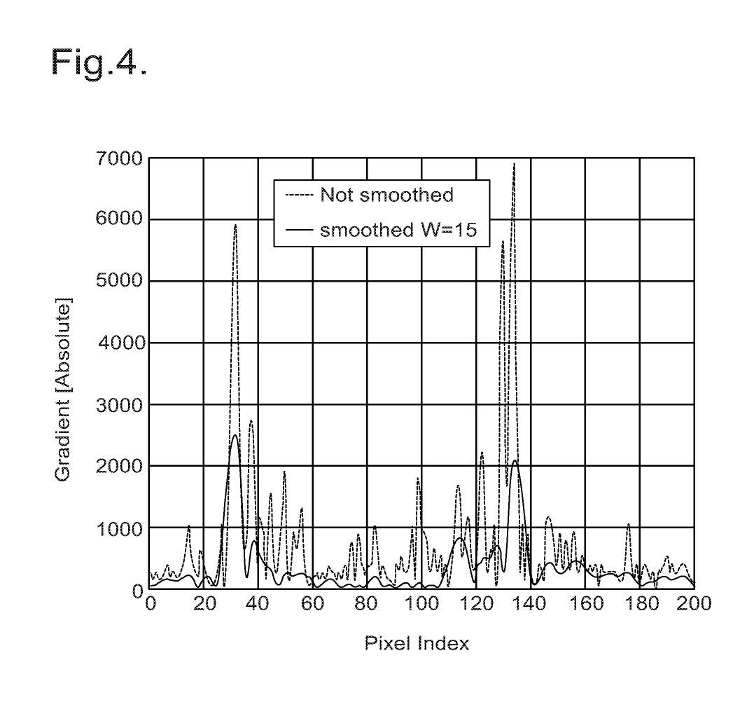

FIG. 4 shows the gradient data of FIG. 3, alongside smoothed gradient data;

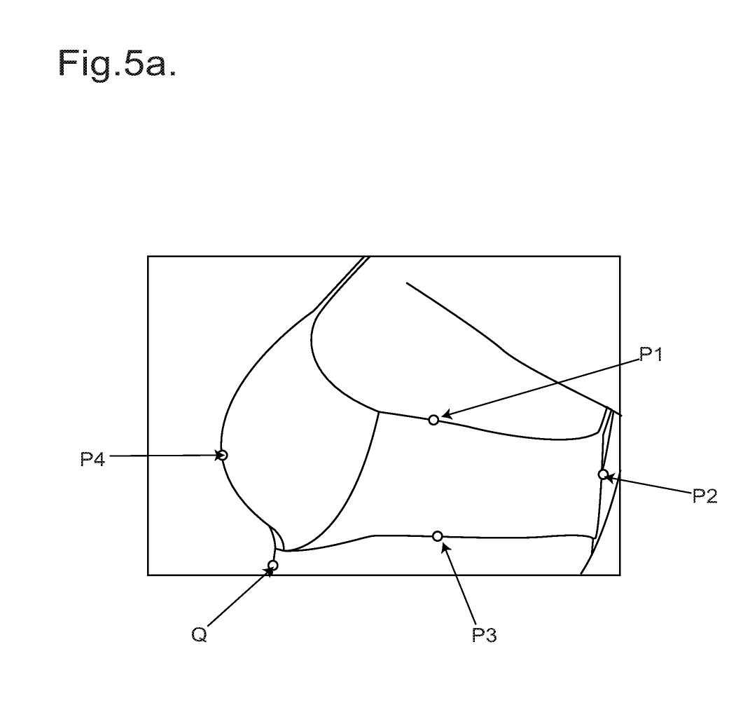

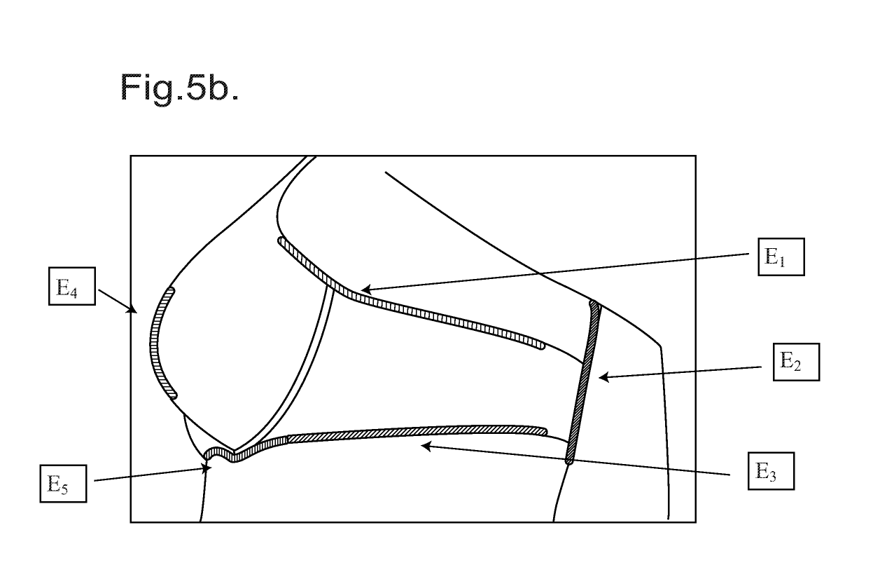

FIG. 5(a) shows an image of a wearer in a bra with four anchoring points for four different sectors marked on;

FIG. 5(b) shows an image of a wearer in a bra with five different edges marked on;

FIG. 1 is a flow diagram 100 of the overall steps that are carried out in this image processing method:

Step 102 is to load the image to be processed onto the image processing system or apparatus. The image may be acquired from a mobile device, such as a mobile telephone, or a tablet device, or from a standard camera. In some embodiments of the invention, the image may be a smaller part of a larger overall image. Furthermore, the originator of the image may be remote from the image processing apparatus, for example in a different building, or even in a different country and may simply provide an electronic version of the image for processing. In one embodiment of the invention the image processing may be run entirely within the platform/hardware in which the image is captured. In this case, no information concerning the image needs to be sent to an external body. Alternatively, the image may also be loaded on to a separate image processing system and processed remotely.

In one embodiment of the invention, the image that is acquired for processing may be an image of a female subject wearing a bra for example. The image is generally acquired with no control over the illumination conditions used whilst the image is acquired. For example, the image may be acquired using flash illumination, or acquired in conditions of daylight or artificial light, over a range of different light intensities. This variation in the level of illumination may give rise to irregular levels of reflections in the image, which may cause objects or different regions in the image to appear to consist of different colours. Given the range of illumination conditions over which the image may be obtained it has been found that simple shape matching algorithms (as known from the prior art) are inefficient in the precise detection of features of interest within the image.

Furthermore, the image may include details of a garment (the bra, for example), and in some cases the garment maybe a single colour or a range of colours and/or the garment may be plain, but more typically some or all of the garment may be provided with one or more patterns, that may vary over some or all of the entire garment. Additionally the garment may sometimes be of a colour that is close to the colour of the background of the image.

Therefore, simply analysing the plurality of colours in the image would not be feasible. Instead, the current invention analyses patterns in the change in colour in the image, which gives rise to a change in colour gradient over the image. A transition from one colour to another colour within the image is indicated by peaks in the gradient curve plotted in absolute values. By analysing the gradient peaks, edges relating to the features of interest in the image could be efficiently identified. This analysis of the image is described in more detail later in this description.

In addition, it is very likely that the bra or garment that the subject is wearing will not be standard, but instead the bra or garment typically comes in a variety of different shapes and patterns, which will pose challenges for shape matching algorithms.

Step 104 is the image correction step, and includes steps such as brightness adjustment and/or alignment adjustment. Typically, this will be done using standard techniques that are well known in the field of image processing. Other standard image correction steps may also be carried out at this stage.

Step 106 is to select an area of the image of particular interest for processing. This may be the entire image, but more typically it will be a particular subsection of the image. For example, if the image is of a wearer and a bra for example, then the area of interest may be the part of the image covering the boundary between the edge of the garment and the wearer's body. Alternatively, the wearer maybe a female subject wearing a swimming costume with integral breast supports, or a bikini, or some other type of underwear with appropriate breast support. In this case, the area of interest may be a specific area of the body covered by all or part of the garment.

Step 108 is to combine the colours in each pixel of the selected area to obtain a combined colour image (as described in more detail later), this step also includes the step of calculating the colour gradient data for the combined colour index.

At step 110 the colour gradient data is smoothed, typically by convolving the colour gradient data with a Gaussian window.

At step 111 an initial sectoring operation is performed.

At this stage, the user then has two alternatives. They may proceed via steps 112 and 114, or via steps 150-152. Both options will lead to step 118.

In steps 112 and 114 anchoring points for the image are identified, and then gradient changes that are relevant to the detection of the subject in the image are identified. This may identify the boundary between the garment and the wearer as mentioned above.

This leads to step 116, where the image is then sectored into sub-sectors.

In certain cases, extraction or identification of anchor points from an image to be detected may not be possible with the required level of certainty. This may be caused by high variance of background noise and/or due to high variations of the features to be matched. In such cases, an alternate means of identifying the relevant edges in the image, or selected area of the image without the use of anchor points is required.

At Step 150, spatially distributed gradient data is calculated and then clustered based on a pixel distance limiting factor. The calculation of spatially distributed gradient data is done either along the X axis or Y axis of the image as appropriate.

By analysing this gradient data, edges present in image can be determined. The two dimensional area of the image over which such analysis is carried out maybe significantly reduced, if the image is sectored in an appropriate manner. Methods of sectoring an image for solving a particular problem are based on the nature of the problem, by understanding where and how the features to be extracted are located and aligned in the image.

The edges in a two dimensional area are present as binary values, along relevant columns and rows that are indicative of each pixel of the area of the image. An edge will generally appear as a continuous line of connected pixels. It is therefore proposed to search for the pixels representing edges, and to cluster them using a pixel distance limiting factor. The pixel distance limiting factor is introduced such that the continuity of the pixels containing edges will be identified even if some pixels do not appear to be a part of an edge, for example due to issues relating to presence of random noises and/or the uneven distribution of brightness in the image. For each of the possible edges that are obtained from the clustered gradient data, a gradient operation is performed on the spatial distribution of the edge along either the X axis or Y axis. The selection of axis along which the spatial gradient to be calculated is not fixed and depends mainly on how typically the final edge or edges to be identified are oriented.

As an example, if a particular feature of an image is usually vertically oriented, then obtaining the gradient of the edge along Y (vertical) axis is recommended. In practise, the object and related edges may not be present in a fixed orientation in an image and could be rotated arbitrarily. However, as obtaining spatial gradient information along either of the axes is possible for very large angle of orientation, the proposed method facilitates great degrees of rotations.

Once the gradient data for each of the clustered edges is obtained, the one dimensional data is compared with the predetermined one dimensional template that represents the shape of the particular edge to be identified. This is step 151. A scaling function may be employed to scale the gradient data up or down, thereby matching the predetermined template with each edge. A suitable probability of detection is computed for each of the edges, and edges with probabilities above a certain threshold are selected for a particular feature.

An object as a whole typically contains more than one edge. From the method mentioned above, sets of possible edges are obtained representing each feature of the object. For each combination of edges, an overall shape conformity check is employed to select the combination of edges that best matches the features in the object to be identified. This is step 152.

The overall idea behind identifying an edge containing a number of pixels, as opposed to identifying a single anchor point with only one pixel is to increase the confidence in the initial detection of necessary locations for subsequent looping. As mentioned previously, the presence of high variations of noise and high variations in the features of the image are such that detecting a set of anchor points for the image cannot be carried out with sufficient confidence, in this case, sets of pixels pertaining to an edge are analysed and selected instead. This increases the confidence in the initial detection of the feature. It is important to note that subsequent looping functions (see below) to detect a whole contour in the image still has to be carried out, as the edges detected as a set of pixels will not present the full length of the feature. As shape matching is carried out only along a single dimension, the proposed method supersedes traditional two dimensional shape matching in terms of computational simplicity.

In step 118 (after steps 116 and 152) relevant sectors are looped in to detect particular features in the image, for example, contours, or flat areas. This looping step is required to ensure all pixels in an edge of interest are detected. Initially, in the two pathways given by steps 111-116 or 111-152 several points on the edge (the feature of interest) will be detected. However, the edge (the feature of interest) will consist of many more pixels than have been detected by steps 111-116 or 11-152. Therefore, the looping step 118 is carried out to detect the remaining pixels in the edge, with the pixels that have already been detected in the foregoing steps serving as a basis for the looping operation.

Finally, in step 120 relevant data is returned following all the image processing steps. Relevant data is edge data of the detected edges. So for example, if the image is an image of a user wearing a bra, the relevant data may include the edge representing the bra cup, the edge of the bra under the bar wire, the edge of the bra wings and the edge of the back of the wearer.

As is well known, colour can be represented by three primary colours: Red, Green and Blue. FIG. 2 depicts the primary colour breakdown for an acquired image across 200 pixels of the image. As shown, the original image has a high colour variance. The values for each of the three colours, red, green and blue will be the input at step 108 of FIG. 1 to produce a combined colour index across the 200 pixels. It is observed that, for this specific image the trend across the graph of the three primary colours is similar but not exact. For example, all three colours have a trough at approximately 30 pixels, then a peak at approximately 80, a trough at approx. 85-90, another peak at approx. 90, a trough at approx. 115 etc. Furthermore, the magnitudes of the three primary colours vary at different pixels. Typically, in this image, the magnitude of the red colour is greatest across the pixels and the magnitude of the blue colour is smallest across the pixels.

A suitable method of combining the three primary colours is necessary to enable efficient extraction of information from the pixel colours, and to reduce the information space. In one embodiment of the invention, for digital 8 bit information where the colour intensity varies between 0 to 255 (a total of 256 different values=2⁸), a single combined colour index is calculated by the following equation:

Combined colour index=(256*256*Red)+(256*Green)+Blue

In the above equation the values for Red, Green and Blue as inserted in the above equation range from 0 to 255 (256 values in total). The simple linear combination shown above is used to combine information about the three colours to give a unique index for all the combination of 2²⁴ colour values. However, the equation can apply to any range of colour values. For example, if the colour intensity varies from 0-999 (1000 values in total) then the equation would be:

Combined colour index=(1000*1000*Red)+(1000*Green)+Blue

More generally, the colour index is represented as:

Combined colour index=(Z²*Red)+(Z*Green)+Blue

Where Z is equal to (upper limit+1) of the range of values for the colours, and red, green, blue are the actual colour intensity value (between 0 and (Z−1) for each specific pixel.

Use of the combined index reduces the information space from consideration of three variables (three different colours) into only one variable (the combined colour index). The combined colour index can then be used for the generation of colour gradient data. More specifically, a change in the overall colour across the pixels will also be visible as a change in the gradient of the combined colour index. Therefore a gradient calculation operation is carried out on the combined colour index. It has been found that processing the subsequent gradient information is comparatively simple compared with processing the raw combined data.

Typically, analysing gradient data (acquired as described below) is used for identifying relevant edge features in the image. However, in extracting information on certain types of features, the depth of information from the gradient data alone may be insufficient and additional information regarding the colour distribution of the features may be used to further analyse the image. For example, when determining a feature such as the distribution of brightness across the feature, (which may vary due to the state of illumination of the image), analysis of the colour distribution over the image is required. In such instances, the combined colour index could be utilised to render a simple means of extracting relevant information from the image, without requiring the additional step of calculation of gradient data.

FIG. 3 depicts the colour gradient information obtained from the combined colour index calculated from the data in FIG. 2, this can be obtained using standard mathematical and computing techniques. In a preferred embodiment of the invention, for a one dimensional array D of length N: D(1), D(2) . . . D(N−1), D(N) The gradient G, at k^{th} index is given by:

G(k)=0.5*(D(k+1)−D(k−1)),

where

2≦k≦N−1

and that

G(1)=D(2)−D(1)

G(N)=D(N)−D(N−1)

As shown, the scale of FIG. 3 is plotted in absolute values to convert any negative values to positive values. This has the effect of further simplifying the analysis. Each peak on the graph of FIG. 3 relates to a change in colour within the image, which can be effectively utilised to infer information about particular features within the image.

The gradient curve in FIG. 3 also indicates the presence of noise and jitter arising from rogue pixels that may be due to:

a) Poor quality of the camera,

b) Light conditions in which the image was acquired.

Of course, the noise and/or jitter may have arisen for other reasons as well.

Filtering noise and/or jitter requires efficient smoothing of the gradient data to highlight the gradient changes that are relevant to features on the image. This corresponds to step 110 of FIG. 1. The smoothing operation is carried out on the gradient data rather than raw pixel data since smoothing the raw pixel data may result in the possibility of masking important features.

To perform smoothing of the gradient data, a Gaussian window is convoluted with the gradient data information. The length of the Gaussian window to be used in the convolution is determined based on the end usage of the processed image, and is set to be sufficient to suppress the noise but to preserve all the data that may be of interest. For example, in one embodiment of the invention, for an image that was acquired in a garment fitting room, a length of the Gaussian window of 15 was deemed to be sufficient for adequate smoothing. This technique provides a simple but computationally fast method that is effective to remove noise and/or jitter from image data.

FIG. 4 compares the original gradient data and the smoothed gradient data obtained using a Gaussian window of length 15 for the data of FIG. 3. It is observed that the smoothing operation is able to suppress the noise and jitter, that may have arisen as discussed above, and to highlight the important features of the image with reference to the raw colour data as shown in FIG. 2. Whilst Gaussian convolution is the preferred smoothing method, any moving weighted average smoothing technique may be applied to the data as appropriate. The smoothing that is carried out by these methods is simple, computationally fast and independent of the feature being smoothed.

Further analysis of the raw and smoothed data of the graphs in FIG. 4 reveals similar trends in the change in gradient for both data sets within certain neighbourhoods of the image. Though these trends are not identical, their close similarity allows them to be loosely clustered together in terms of logic pertaining to identification of features. For example, if the image is of a side profile of a wearer in a bra, as shown in FIGS. 5(a) and 5(b), then these trends in the change in colour gradient data can be used to identify the edge of the bra on the wearer's body. The action of clustering trends in colour gradient data together provides an effective means of sectoring the image in an appropriate manner, so that different sets of logic can be developed to extract information from relevant sectors of the images. For example, a garment that a user is wearing in the image may have a printed pattern on. In this case, an edge of the garment may have a series of gradient peaks (due to the repeating pattern on the garment) rather than just a single gradient peak. In this case, the series peaks representing each different edge will be clustered together so each edge is appropriately categorised/clustered. Information that may be used to facilitate the clustering process may include relative values of the gradient peaks (for each edge)and/or relative distance between the gradient peaks for example. In this manner, a small subset of the image (a sector) can be subsequently analysed for features within that sector, rather than by analysing the entire image in one go.

Before the algorithm for analysing the colour gradient data is finalised, or used on a live image to detect a specific feature, it will have been carefully refined through the use of multiple assorted training images. In this case, the training images will typically be images of a female subject wearing a bra, swimwear, or other close fitting article of clothing with integral breast support. The training images may be acquired in a range of different directions, in different light conditions, and using a range of different acquisition devices (cameras, mobile devices, mobile telephones etc.) to provide a wide variety of training images. Furthermore, the training images will cover a wide variety of skin tones, body shapes and sizes as well as different styles of bra. Of course, other types of training images may also be used.

In this embodiment of the invention, the algorithm needs to be able to easily identify the wings of the bra, the cup of the bra and the back of the wearer in the image to be analysed. After sufficient training images have been presented and analysed, the algorithm is refined so that it can easily identify trends in colour gradient data that are relevant to a specific edge to be identified. In a preferred embodiment of the invention this is the upper and lower edges of the wings of the bra, the edge of the bra cup, and the edge corresponding to the back of the wearer.

Once these approximate boundaries have been determined for a specific live image, the image may be sectored as described above, and colour gradient data is analysed for the selected sector of the image to determine the position of various anchor points for each sector of the image.

FIG. 5(a) shows various anchor points P1-P4 (corresponding to the upper edge of the bra wing, the back of the wearer, the lower edge of the bra wing, and the outer edge of the cup of the bra respectively). An additional anchor point Q is also shown in this figure, on the wearers' torso just below the underneath of the bra cup.

To determine the location of the anchor points P1-P4 (as required by step 112 in FIG. 1) the colour gradient data is further analysed by determining one or more of:

a. Values of gradient peaks relative to each other;

b. Locations of gradient peaks and occurrences relative to each other;

c. Clusters of gradient peak governed by distance limiting factors.

Preferably, anchor points P1-P4 are located in the centre of the edge of the feature to which they correspond. This is simply to provide for easier computation and analysis, and in an alternative embodiment of the invention the anchor points may be located at any point along the corresponding edge. Typically, anchor points P1 and P3, corresponding to the horizontal edges (the upper and lower edges of the wing of the bra) are determined first. Once these anchor points are fixed for the image, the location of P1 and P3 can assist in determining the location of points P2 (the anchor point on the centre of the bra at the back of the wearer) and P4 (the anchor point on the centre of the front of the cup) on the image. Anchor point Q as shown in FIG. 5(a) is provided merely as an additional anchor point on the image at the location of a boundary between two distinct sectors of the image (where the image has been sectored as discussed above).

Once the anchor points (P1-P4) have been identified on the image they are used to highlight sections of the image which should be analysed in more detail, to look more precisely for edge features of the image which are of interest.

FIG. 5(b) shows various different edge regions that have been identified on the image using the colour gradient data as described above. Edge E1 is the edge between the upper edge of the side wing of the bra and the user's skin. Anchor point P1 is located approximately in the centre of this edge. Edge E2 is the (substantially vertical) edge between the wing of the bra at the back of the user, and the overall background of the image. Anchor point P2 is located approximately in the centre of this edge. Edge E3 is the (substantially horizontal) edge between the bottom edge of the side wing of the bra, and the user's skin. Anchor point P3 is located approximately in the centre of this edge. Edge E4 is the curved edge between the outer edge of the bra cup and the overall background of the image. Anchor point P4 is located approximately in the centre of this edge. Edge E5 is the slightly curved edge between the bottom of the bra cup and the user's skin. This edge does not have a corresponding anchor point. Anchor point Q does not have a corresponding edge.

The logic process to be subsequently described is able to determine the location of each of these edges (E1-E5) in the image. This will be illustrated with respect to edge E3, but is applicable to all the edges discussed above.

Firstly, it is recognised that edge E3 is the edge of the bottom of the wing of the bra. Therefore, statistically, this edge will always be found within a certain range of distance from the bottom of the image. This limitation on the location of edge E3 is merely to be used as a guide, as the precise human form of the wearer may vary greatly from image to image, which may affect the location of edge E3 in each image. This statistical limitation is in fact only one factor in determining the location of edge E3, Similarly, edge E1 may well have a statistical limitation on the distance from the top of the image, and edges E2 and E4 may have a statistical limitation on the distance from the vertical sides of the image. Of course, for all these edges there may be other factors or statistical limitations that need to be considered in determining the location of the edge.

It is also well known that the overall shape of the edge may vary. As shown in FIG. 5(b), the edge E3 is substantially horizontal, but in some cases the edge E3 could be at an angle to the horizontal and the bra (or other garment that the subject is wearing) could further be provided with a decorative edge for example, which may completely alter the orientation of the edge, by forming a repeating or random pattern for example. In view of this, a simple shape matching algorithm to determine the edge is not really suitable, and a more sophisticated algorithm is preferably pursued instead.

Typically, for a wearer, the skin tone of the wearer will be substantially uniform across the torso of the wearer (the area of interest in the image of FIG. 5(b)), and so there is likely to be a colour transition from a first set of values (corresponding to skin tone) and a second set of values (corresponding to the edge of the bra). This transition can be identified from the colour gradient data previously obtained. This transition may be large or small depending on the difference in colour between the skin tone and the bra or other garment.

The step of looking at the colour transition to identify the edge E1 or E3 should also take account of other variations that may well occur. For example, the bra as worn in the image may have several different colours, and/or may be patterned. The analysis of the colour gradient data to look for colour transitions can take this into account.

With regard to the wearer, it is possible that additional colour variation may also arise due to tattoos, or scarring on the skin, or even changes in the lighting conditions when the image was acquired. Again, the step of looking at the colour transitions will take these possible anomalies into account.

Typically, the image will be sectored (as described above) according to the uniformity of the transitions in the region in the vicinity of the edges. Preferably, the transitions will be substantially vertical, or substantially horizontal, but in some cases the transition may not be so, as in edge E4, related to the bra cup, and E5 related to the base of the bra cup for example.

A distance limiting factor is also introduced to identify peaks and discriminate between peaks that are in close proximity. As shown in FIG. 5(b), edge E3 is the edge between the lower part of the wing of the bra and the user's skin. As the bra has a particular thickness, this may result in a thin shadow that is present in the image, just below the genuine edge. This shadow artefact may give rise to an additional peak, in the colour gradient data, located between the peak from the bra edge and the peak for the skin.

In this case, an algorithm with a distance limiting factor can be used to categorise peaks in such close proximity. By analysis of these peaks, the actual peak related to the edge of the bra can be successfully determined, and the effect of the shadow artefact is removed.

Typically, according to the nature of the image to be processed, the processing techniques applied to the gradient peaks may also differ.

In the preferred embodiment of the invention, the logic process for identifying the anchor points is not the same as the logic process for determining the edges, and typically, the logic for the anchor point determination is more complex, as they are derived from subjectively analysing trends in the gradient patterns of the images.

Furthermore, for more complicated images that may present high random noise and/or jitter and/or high variations in features, several pixels in an edge may be detected, as opposed to simply detecting a single pixel from an anchor point. The methodology proposed presents a computationally simple means of performing such analysis.

Adopting simpler logic algorithms for the sectoral/edge analysis results in much reduced processing time. This reduction in processing time will enable the algorithms to be implemented on a portable platform with low computational power such as a low end smart phone, tablet device or a Raspberry Pi.

Of course, the above described operations as used for the various image processing steps described above may also be susceptible to random occurrences of noise, jitter and/or vast variations features in the image. Therefore, algorithms that can constantly check for erroneous detection have also been built into the logic. These error correction algorithms can:

a. determine the locations of currently detected pixels in relation to the location of preceding pixels.

b. determine the best location based on a distance tolerance set and the pattern of the pixels identified.

c. provide a check method in the case where a location is found to be unattainable. In the check, the proceeding locations are correlated to the previous locations which have been correctly detected.

d. provide a correction from an erroneous trail of features, back to the trail of pixels along the correct feature.

Once the pixels that are relevant to particular features in the image have been identified, such as the pixels that are part of edges E1-E4, for example, it is possible to use information on these pixels to calculate information about the image, such as distance between features, for example It may be possible to calculate the length of any of the edges E1-E4, or the distance between points different edges for example.

Other variations and modifications of the image processing method will be apparent to the skilled person. Such variations and modifications may involve equivalent and other features that are already known and which may be used instead of, or in addition to, features described herein. Features that are described in the context of separate embodiments may be provided in combination in a single embodiment. Conversely, features that are described in the context of a single embodiment may also be provided separately or in any suitable sub-combination.

1. An image processing method comprising the steps of:
acquiring an image to be processed;
calculating a combined colour index for each pixel in said image, based on the colours contributing to each pixel;
calculating a one-dimensional gradient of said combined colour index for each pixel to obtain one-dimensional colour gradient change data;
smoothing said gradient change data to highlight colour changes on said image;
sectoring said smoothed gradient change data to allow information to be extracted from each said sector of said image;
and determining one or more edge features within one or more sectors.

2. An image processing method according to claim 1 wherein said step of determining said edge related feature comprises the step of clustering said colour gradient change data.

3. An image processing method according to claim 2 wherein said clustering step is performed using a pixel distance limiting factor.

4. An image processing method according to claim 2 further comprising the step of comparing clustered gradient data with a template representative of the shape of said edge.

5. An image processing method according to claim 4 further comprising the step of using a scaling function to scale the clustered gradient data to match said template.

6. An image processing method according to claim 5 further comprising a conformity check to determine the combination of edges that matches the overall shape of the object in the image.

7. An image processing method according to claim 1 wherein the step of determining at least one edge related feature includes identifying at least one anchor point within one or more sectors.

8. An image processing method according to claim 7 further comprising the step of using at least one of said anchor points to assist in determining an edge feature within said image.

9. An image processing method according to claim 1 wherein said combined colour index for each pixel is calculated as follows:
combined index=(Z×Z×Red)+(Z×Green)+Blue
where Red, Green and Blue represent the magnitude of that primary colour in each pixel, and Z represents the total range of values available for each colour in the image.

10. An image processing method according to claim 9 wherein the value for each of Red, Green, or Blue in the combined index equation is between 0 and 255, and Z is 256.

11. An image processing method according to claim 1 wherein said smoothing is performed by Gaussian convolution.

12. An image processing method according to claim 11 wherein said parameters of said Gaussian convolution are adjusted according to the origin of said image.

13. An image processing method according to claim 12 wherein the origin of said image is a photograph acquired with a mobile device.

14. An image processing method according to claim 1 wherein said sectoring is performed using a logic process.

15. A image processing method according to claim 14 wherein said logic process clusters similar colour gradient data together.

16. A method according to claim 7 wherein said anchoring point is a single pixel within said sector.

17. A method according to claim 7 further comprising the step of identifying additional anchor points for each said sector to assist in defining one or more boundaries of said sector.

18. A method according to claim 16 wherein the location of said anchoring point is determined by a logic process.

19. A method according to claim 1 wherein information is extracted from one or more sectors by a logic process.

20. A method according to claim 19 wherein said logic process is based on one or more of:
a) values of peaks within said sector relative to each other;
b) location/occurrence of peaks within said sector relative to each other; and
c) clusters of peaks governed by distance limiting factors.

21. A method according to claim 14 wherein said logic process further comprises one or more error correction steps.

22. A method according to claim 1 further comprising the step of analysing the colour distribution within said image by analysing said combined colour index.

23. An image processing method according to claim 22 wherein the results of analysing said colour distribution can be used to identify colour based features in said image.

24. An image processing apparatus for image processing comprising:
means of acquiring an image to be processed; and
processor means for processing said acquired image;
said processor means:
calculating a combined colour index for each pixel in said image, based on the colours contributing to each pixel;
calculating a one-dimensional gradient of said combined colour index for each pixel to obtain a one-dimensional colour gradient change data;
smoothing said gradient change data to highlight colour changes on said image;
sectoring said smoothed gradient colour change data to allow information to be extracted from each said sector of said image; and
determining one or more edge features within one or more sectors.
